(19) United States
(12) Patent Application Publication
(10) Pub. No.: US 2008/0025145 A1
(43) Pub. Date: Jan. 31, 2008

(54) Ultrasound Imaging Probe Featuring Wide Field of View

(75) Inventors: Michael Peszynski, Newburyport, MA (US); David G. Miller, North Andover, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,912

(22) PCT Filed: Apr. 12, 2005
(86) PCT No.: PCT/IB05/51205

§ 371 Date: Oct. 13, 2006

Related U.S. Application Data
(60) Provisional application No. 60/562,032, filed on Apr. 14, 2004.

(51) Int. Cl. G03B 42/06

(52) U.S. Cl. 367/7

(57) ABSTRACT

According to an embodiment of the present disclosure, a wide field of view ultrasound imaging probe (12) includes two flat matrix array subassemblies (40,42) positioned at an angle to each other within the probe (12). Information from each array subassembly (40,42) is combined for producing data corresponding to a wide-angle field of view image.

The present disclosure generally relates to ultrasound devices and methods for imaging internal portions of a subject, and more particularly, to a wide field of view ultrasound imaging probe.

Ultrasound imaging has been widely used to observe tissue structures within a human body, such as the heart structures, the abdominal organs, the fetus, and the vascular system. Ultrasound imaging systems include a transducer array connected to multiple channel transmit and receive beamformers applying electrical pulses to the individual transducers in a predetermined timing sequence to generate transmit beams that propagate in predetermined directions from the array. As the transmit beams pass through the body, portions of the acoustic energy are reflected back to the transducer array from tissue structures as reflected pressure pulses having different acoustic characteristics.

Receive transducers (which may be transmit transducers operating in the receive mode) convert the reflected pressure pulses into corresponding radio frequency (RF) signals that are provided to the receive beamformer. Due to different distances traveled by the reflected pressure pulses to the individual transducers, the reflected sound waves arrive at the individual transducers at different times. Accordingly, the corresponding RF signals have different phases.

The receive beamformer includes a plurality of processing channels with compensating delay elements connected to a summer. The receive beamformer uses a delay value for each channel and collects echoes reflected from a selected focal point. Consequently, when delayed signals are summed, a strong signal is produced from signals corresponding to this point, but signals arriving from different points, corresponding to different times, have random phase relationships and thus destructively interfere. Furthermore, the beamformer selects the relative delays that control the orientation of the receive beam with respect to the transducer array. Thus, the receive beamformer can dynamically steer the receive beams that have desired orientations and focus them at desired depths. In this way, an ultrasound imaging system acquires echo data.

Non-invasive, semi-invasive and invasive ultrasound systems have been used to image biological tissue of the heart and the vascular system. A doppler ultrasound imaging systems is an example of a non-invasive system used to determine blood pressure and blood flow within the heart and the vascular system of a patient. To image the heart, the transmit beamformer focuses the emitted pulses at relatively large depths, and the receive beamformer detects echoes from structures located 10-20 cm away, which are relatively far in range.

An example of a semi-invasive systems includes a transesophageal imaging system, and the invasive systems include intravascular imaging systems. A transesophageal system includes an insertion tube with an elongated semi-flexible body made for insertion into the esophagus. The insertion tube is about 110 cm long, has about a 30 F diameter and includes an ultrasonic transducer array mounted proximate to the distal end of the tube. The transesophageal system also includes control and imaging electronics including the transmit beamformer and the receive beamformer connected to the transducer array.

The intravascular imaging systems use an intravascular catheter that requires different design considerations from a transesophageal catheter. The design considerations for an intravascular catheter are unique to the physiology of the vascular system or to the physiology of the heart. The intravascular catheter has an elongated flexible body about 100-130 cm long and about 8 F to 14 F in diameter. The distal region of the catheter includes an ultrasonic transducer mounted proximate of the distal end. To image the tissue, several mechanical scanning designs have been used. For example, a rotating transducer element or a rotating ultrasound mirror is used to reflect the ultrasound beam in a sweeping arrangement. Furthermore, catheters with several transducer elements have been used, wherein different transducer elements are electronically activated to sweep the acoustic beam in a circular pattern. This system can perform cross-sectional scanning of arteries by sweeping the acoustic beam repeatedly through a series of radial positions within the vessel. For each radial position, the system samples the scattered ultrasound echoes and stores the processed values. However, these ultrasound systems have a fixed focal length of the reflected acoustic beam. The fixed focal length significantly limits the resolution to a fixed radius around the catheter.

Furthermore, intravascular ultrasound imaging has been used for determination of the positions and characteristics of stenotic lesions in the arteries including the coronary arteries. In this procedure, a catheter with a transducer located on the tip is positioned within an artery at a region of interest. As the catheter is withdrawn, the system collects ultrasound data. The imaging system includes a catheter tracking detector for registering the position and the velocity of the transducer tip. The imaging system stacks two-dimensional images acquired for different positions during the transducer withdrawal. An image generator can provide three-dimensional images of the examined region of the blood vessel or the heart, but these images usually have low side penetration.

Recently, ultrasound catheters with the above-described mechanical, rotating transducer designs have increasingly been used in the assessment and therapy of coronary artery diseases. These catheters have a larger aperture, giving rise to deeper penetration depths, which allows imaging of tissue spaced several centimeter away from the transducer, such as the right atrium of the human heart. These images can assist in the placement of electrophysiology catheters. However, these devices still do not provide high quality, real time images of selected tissue regions since they have somewhat limited penetration, a limited lateral control and a limited ability to target a selected tissue region. In general, the produced views are predominantly short axis cross-sectional views with a low side penetration.

Currently, interventional cardiologists rely mainly on the use of fluoroscopic imaging techniques for guidance and placement of devices in the vasculature or the heart as performed in a cardiac catheterization laboratory (Cathlab) or an electrophysiology laboratory (Eplab). A fluoroscope uses X-rays on a real-time frame rate to give the physician a transmission view of the chest cavity, where the heart resides. A bi-plane fluoroscope, which has two transmitter-receiver pairs mounted at 90.degree. to each other, provides real time transmission images of the cardiac anatomy. These images assist the physician in positioning the catheters by providing him (or her) with a sense of the three-dimensional geometry in his (or her) mind that already understands the cardiac anatomy. While fluoroscopy is a useful technique, it does not provide high quality images with real tissue definition. The physician and the assisting medical staff are required to cover themselves with a lead suit and need to limit the fluoroscopic imaging time when ever possible to reduce their exposure to X-rays. Furthermore, fluoroscopy may not be available for some patients, for example, pregnant women, due to the harmful effects of the X-rays. The transthoracic and transesophageal ultrasound imaging techniques have been very useful in the clinical and surgical environments, but have not been widely used in the Cathlab or Eplab for patients undergoing interventional techniques.

What is needed, therefore, is an ultrasound system and method for effective intravascular or intracardiac imaging that can visualize three-dimensional anatomy of a selected tissue region. Such system and method would need to use an imaging catheter that enables easy manipulation and positional control. Furthermore, the imaging system and method would need to provide convenient targeting of the selected tissue and good side penetration allowing imaging of near and more distant tissue structures, such as the right and left sides of the heart.

In addition to the above, specialized ultrasound transducers are used for Intracardiac (ICE) or intracavity (TEE, TVE, and others) echo imaging of various human anatomy. The field of view available from these devices is limited to +/−45 degrees from the phased array. In many cases, it would be desirable to increase the field of view available from these probes. However, interrogation of an anatomy outside the standard 90 degree phased array format requires much probe manipulation. Furthermore, 3D volume scanning is subject to the same limitations in each plane. This is a serious limitation.

Accordingly, there exists a need for a wide field of view imaging catheter or intracavity probe. Curved linear array transducers are known in the art for their ability to provide a wider field of view over that of a standard flat 1D phased array. However, a problem with curved arrays is that the curved arrays are difficult to manufacture with a small radius of curvature. Furthermore, curved arrays will be more difficult and therefore expensive to fabricate in a matrix (2D array) array format that would be capable of scanning a volume to provide 3D imaging.

Accordingly, an improved ultrasound imaging probe and system for overcoming the problems in the art is desired.

According to one embodiment of the present disclosure, an ultrasound imaging probe includes a first ultrasound imaging transducer array subassembly having a first image field of view and a second ultrasound imaging transducer array subassembly having a second image field of view. The second ultrasound imaging transducer array subassembly is disposed at an angle greater than or equal to ninety degrees and less than or equal to one hundred eighty degrees (90°≦angle≦180°) with respect to the first ultrasound imaging transducer array subassembly, such that the second image field of view includes a portion thereof that is different from the first image field of view and wherein the first image field of view and the second image field of view together provide a combined image field of view.

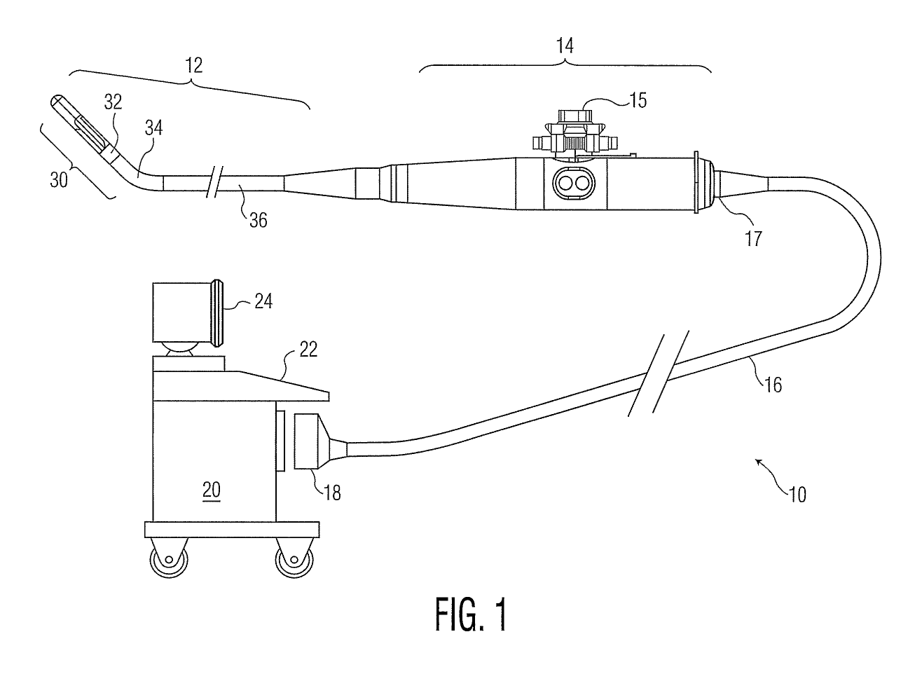

FIG. 1 is a block diagram view of an ultrasound imaging system including a wide field of view ultrasound probe according to one embodiment of the present disclosure;

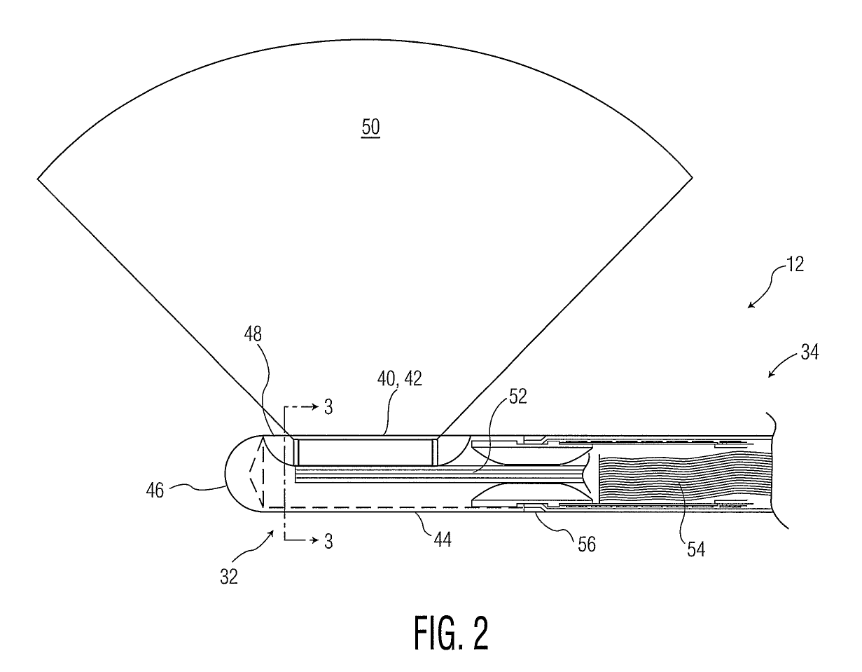

FIG. 2 is a side view of a wide field of view ultrasound probe of FIG. 1 with first and second transducer subassemblies according to an embodiment of the present disclosure;

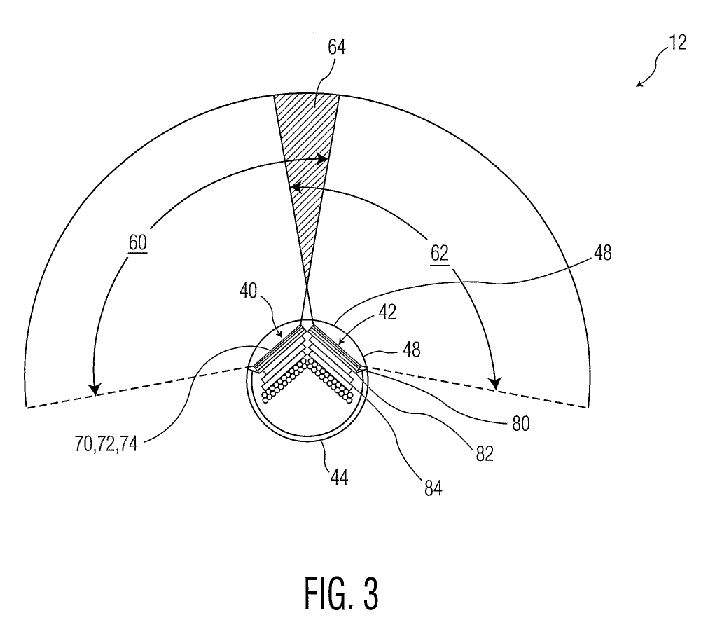

FIG. 3 is a cross-sectional view of the wide field of view ultrasound probe of FIG. 2 taken along line 3-3 according to one embodiment of the present disclosure;

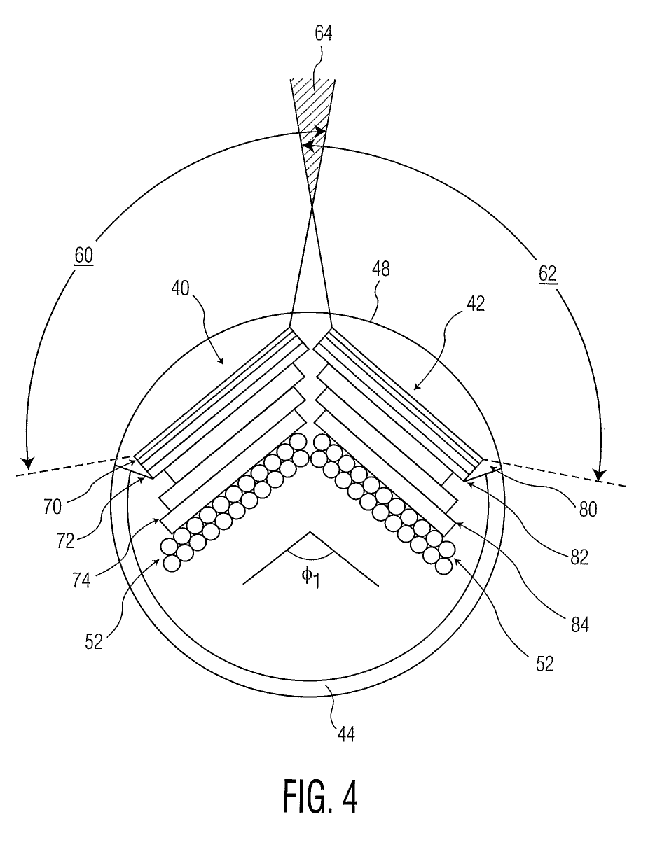

FIG. 4 is an enlarged cross-sectional view of the wide field of view ultrasound probe of FIG. 3;

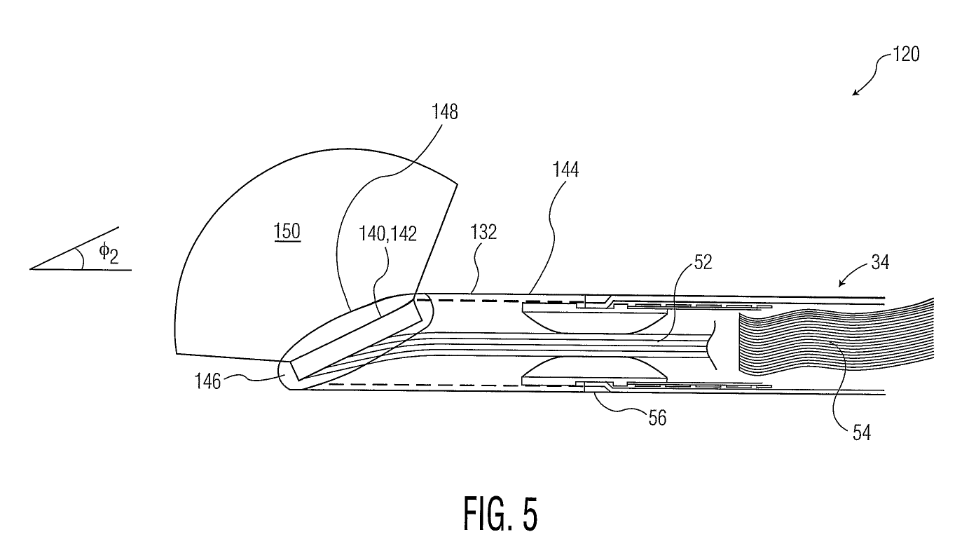

FIG. 5 is a side view of a wide field of view ultrasound probe with first and second transducer subassemblies canted at an angle to the probe body according to another embodiment of the present disclosure; and

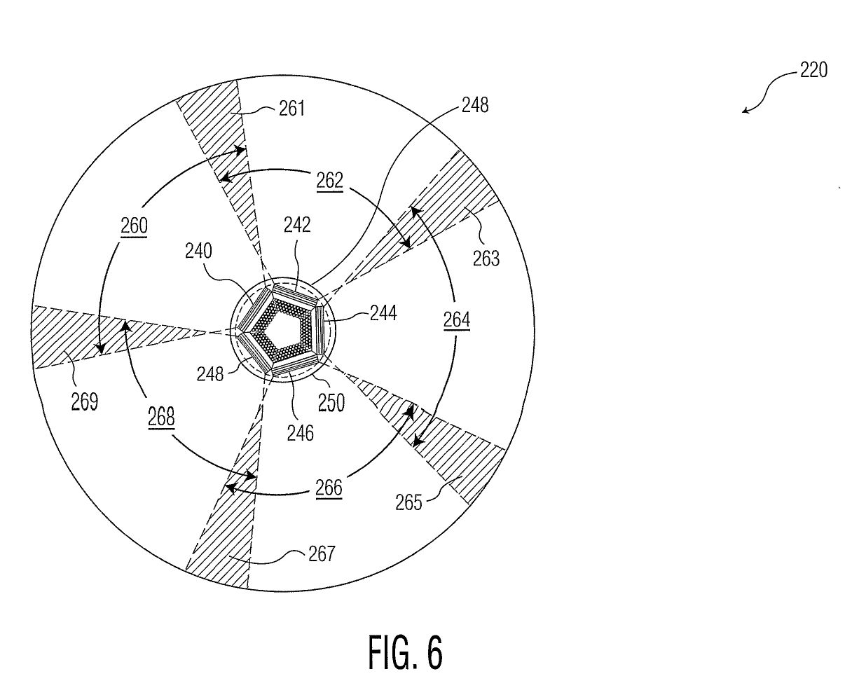

FIG. 6 is a cross-sectional view of the wide field of view ultrasound probe with first, second, third, fourth, and fifth transducer subassemblies according to yet another embodiment of the present disclosure.

FIG. 1 is a block diagram view of an ultrasound imaging system 10 including a wide field of view ultrasound probe 12 according to one embodiment of the present disclosure. In one embodiment, ultrasound imaging system 10 includes a transesophageal (TEE) imaging system and ultrasound probe 12 includes a transesophageal probe.

Ultrasound probe 12 couples via a probe handle 14, a cable 16, a strain relief 17, and a connector 18 to an electronics box 20. Electronics box 20 interfaces with an input device 22, such as a keyboard, and provides imaging signals to a video display 24. Electronics box 20 may further provide ultrasound imaging data to other devices (not shown), such as a printer, a mass storage device, computer network, etc. In one embodiment, electronics box 20 includes, for example, any suitable transmit beamformer, receive beamformer, image generator, controller and/or processor, known in the art for carrying out various functions as discussed herein below.

Ultrasound probe 12 further includes a distal part 30 connected to an elongated semi-flexible body 36. The proximal end of elongated part 36 is connected to the distal end of probe handle 14. Distal part 30 of probe 12 includes a rigid region 32 and a flexible region 34, wherein the flexible region 34 connects to the distal end of elongated body 36. Probe handle 14 includes a positioning control 15 for articulating flexible region 34 and thus orienting rigid region 32 relative to a region or tissue of interest. Elongated semi-flexible body 36, as well as flexible region 34, are constructed and arranged for insertion within a cavity of the subject being examined with the ultrasound probe 12, for example, into an esophagus. Various ones of the mechanical components of ultrasound probe 12 can be provided by using a commercially available gastroscope, for example. In one embodiment, the insertion tube is about 110 cm in length and has about 30 F in diameter. Gastroscopes are commercially available, for example, from Welch Allyn of Skananteles Falls, N.Y. Ultrasound probe 12 further includes a distal rigid end region 32, as shown and described herein below with reference to FIGS. 2 and 3, according to an embodiment of the present disclosure.

FIG. 2 is a side view of a wide field of view ultrasound probe 12 of FIG. 1 with first and second transducer subassemblies (40,42) according to an embodiment of the present disclosure. The distal rigid end region 32 of ultrasound probe 12 includes a portion of sensor housing 44 and a distal tip 46 of the sensor housing. The distal rigid end region 32 of probe 12 includes an acoustic window 48 disposed within a region of the fields of view of the first and second transducer subassemblies (40,42). Acoustic window 48 includes, for example, PEBAX (polyether-block co-polyamide polymers), RTV silicone, urethane, or any suitable material that allows ultrasound energy to traverse the same and wherein the ultrasound energy remains substantially unattenuated by the material of the acoustic window. As shown in FIG. 2, the first and second transducer subassemblies (40,42) produce a combined lateral image field, generally indicated by reference numeral 50.

Probe 12 also includes interconnects 52. In one embodiment, interconnects 52 include application specific integrated circuit (ASIC) to system interconnect cabling. At one end, the ASIC to system interconnect cabling 52 couples to the first and second transducer assemblies (40,42) via ASIC cabling interconnects (74,84) as will be discussed further herein below with reference to FIG. 3. At the other end, the ASIC to system interconnect cabling 52 couples to system interconnects 54 of flexible region 34, proximate a coupling region indicated by reference numeral 56.

FIG. 3 is a cross-sectional view of the wide field of view ultrasound probe 12 of FIG. 2 taken along line 3-3 according to one embodiment of the present disclosure. The view of FIG. 3 is oriented perpendicular to the side view shown in FIG. 2. As illustrated in FIG. 3, the first transducer subassembly 40 produces a first elevation image field of view indicated by reference numeral 60. The second transducer subassembly 42 produces a second field of view, indicated by reference numeral 62. A region of overlap between the first and second fields of view (60,62) is illustrated by reference numeral 64. The region of overlap 64 corresponds to an image splice area, wherein ultrasound imaging information of first field of view is combined (and/or spliced) in a suitable manner with ultrasound imaging information of the second field of view in the region of overlap.

First transducer subassembly 40 generally includes a sensor stack 70, a flip chip ASIC 72, and cabling interconnects 74 that couple to cabling 52. Second transducer subassembly 42 generally includes a sensor stack 80, a flip chip ASIC 82, and cabling interconnects 84 that couple to cabling 52. In one embodiment, sensor stacks 70 and 80 each include a flat matrix array of ultrasound transducer elements, such as disclosed in U.S. Pat. No. 6,551,248, assigned to the assignee of the present invention, and incorporated herein by reference. In another embodiment, sensor stacks 70 and 80 may each include a curved matrix array of ultrasound transducer elements, wherein the curved matrix array of transducer elements has a radius of curvature in a range on the order of 8 mm to flat.

FIG. 4 is an enlarged cross-sectional view of the wide field of view ultrasound probe of FIG. 3. Again, first transducer subassembly 40 generally includes a sensor stack 70, a flip chip ASIC 72, and cabling interconnects 74 that couple to cabling 52. Second transducer subassembly 42 generally includes a sensor stack 80, a flip chip ASIC 82, and cabling interconnects 84 that couple to cabling 52. As shown in FIG. 3, first transducer subassembly 40 is at an angle with respect to second transducer subassembly 42 along a width dimension of the respective transducer subassemblies, indicated by angle Φ₁. In one embodiment, the angle Φ₁ comprises an angle in a range on the order of 90 to 180 degrees.

In one embodiment, the ultrasound imaging probe 12 includes a first ultrasound imaging transducer array subassembly 40 having a first image field of view 60 and a second ultrasound imaging transducer array subassembly 42 having a second image field of view 62. The second ultrasound imaging transducer array subassembly 42 is disposed at an angle Φ₁ with respect to the first ultrasound imaging transducer array subassembly 40. Angle Φ₁ is greater than or equal to ninety degrees and less than or equal to one hundred eighty degrees (90°≦angle≦180°). In addition, the second image field of view 62 includes a portion thereof that is different from the first image field of view 60. Furthermore, the first image field of view 60 and the second image field of view 62 together provide a combined image field of view. The combined image field of view includes a portion 64 thereof in common with both the first and second image fields of view. In other words, the second field of view 62 overlaps with the first field of view 60 in an image splice area 64.

According to another embodiment, the ultrasound imaging probe further includes a housing 44. First and second ultrasound imaging transducer array subassemblies (40,42) are disposed within the housing. In one embodiment, the first and second ultrasound imaging transducer array subassemblies (40,42) are disposed within the housing along a principal axis of the housing. In another embodiment, the first and second ultrasound imaging transducer array subassemblies (40,42) are disposed within the housing canted at an angle to a principal axis of the housing.

Still further, in another embodiment, the first and second ultrasound imaging transducer array subassemblies (40,42) each include a flat matrix sensor assembly, wherein each of the flat matrix sensor assemblies include an acoustic window coupled to a sensor stack, the sensor stack coupled to a flip chip ASIC, and the flip chip ASIC coupled to cabling interconnections. In the ultrasound imaging probe, the first ultrasound imaging transducer array subassembly is responsive to transmit beamforming signals for transmitting sound energy into and receiving echo energy from the first field of view. The second ultrasound imaging transducer array subassembly is also responsive to transmit beamforming signals for transmitting sound energy into and receiving echo energy from the second field of view.

In another embodiment, the ultrasound imaging probe further includes a controller coupled to the first and second ultrasound imaging transducer array subassemblies for combining ultrasound imaging information received from the first and second ultrasound imaging transducer array subassemblies to produce data representative of a combined field of view ultrasound image.

In yet another embodiment, the ultrasound imaging probe includes a cylindrical probe having a principal axis along a length dimension of the probe. Apertures of the first and second ultrasound imaging transducer array subassemblies facilitate a scanning direction perpendicular to the principal axis of the probe. Furthermore, the ultrasound imaging probe includes one selected from the group consisting of an ultrasound imaging catheter and an intracavity probe.

In another embodiment, the ultrasound imaging probe further includes a third ultrasound imaging transducer array subassembly having a third image field of view. The third ultrasound imaging transducer array subassembly is disposed at an angle with respect to the second ultrasound imaging transducer array subassembly. The angle is greater than or equal to ninety degrees and less than or equal to one hundred eighty degrees (90°≦angle≦180°). In addition, the second image field of view includes a portion thereof that is different from the third image field of view, wherein together the first, second, and third image fields of view provide a combined field of view. Furthermore, the ultrasound imaging probe includes a housing, wherein the first, second and third ultrasound imaging transducer array subassemblies are disposed within the housing along a principal axis of the housing.

Referring now to FIG. 5, a side view of a wide field of view ultrasound probe 120 with first and second transducer subassemblies (140,142) canted at an angle to the probe body 144 according to another embodiment of the present disclosure is shown. Various elements of ultrasound probe 120 are similar to corresponding elements of ultrasound probe 12, with the following differences as explained below. Ultrasound probe 120 includes a rigid region 132 and a flexible region 34, wherein the flexible region 34 connects to a distal end of an elongated body, such as elongated body 36 of FIG. 1. In addition, probe 120 includes a generally cylindrical shaped probe body, or sensor housing, 144 having a principal axis along a length dimension thereof.

First and second ultrasound transducer subassemblies (140,142) are generally disposed in a region at the distal tip 146 of probe body 144. In addition, first and second ultrasound transducer subassemblies (140,142) are similar to first and second ultrasound transducer subassemblies (40,42). However, first and second ultrasound transducer subassemblies (140,142) are canted at an angle to the principal axis of the probe body 144, that is, along a length dimension of the respective transducer subassemblies as indicated by angle Φ₂. In one embodiment, the angle Φ₂ comprises an angle in a range on the order of 30 to 90 degrees. Accordingly, first and second ultrasound transducer subassemblies (140,142) produce a combined lateral image field, generally indicated by reference numeral 150 in FIG. 5. Note that the combined lateral image field 150 is also canted at an angle with respect to the principal axis of the probe body 144. The lateral image field 150, in combination with a combined cross-section image field of view of the first and second ultrasound transducer subassemblies (140,142) (now shown in FIG. 5, but similar to that illustrated in FIGS. 3 and 4), enables probe 120 to be used as a forward looking WFOV imaging probe. For example, such a probe can be advantageously used as a forward looking WFOV ultrasound imaging catheter.

In another embodiment, the first and second ultrasound imaging transducer array subassemblies are disposed within the housing along a principal axis of the housing to provide the combined image field of view around a periphery of the housing. In addition, a third ultrasound imaging transducer array subassembly having a third image field of view is disposed within the housing and canted at an angle with respect to the principal axis of the housing. The third ultrasound imaging transducer array subassembly provides a forward looking image field of view ahead of the housing.

In yet another embodiment, the ultrasound imaging probe still further includes a fourth ultrasound imaging transducer array subassembly having a fourth image field of view. The fourth ultrasound imaging transducer array is disposed at an angle greater than or equal to ninety degrees and less than or equal to one hundred eighty degrees (90°≦angle≦180°) with respect to a third ultrasound imaging transducer array. The fourth ultrasound imaging transducer array subassembly is further disposed within the housing and canted at an angle with respect to the principal axis of the housing. Accordingly, the fourth image field of view includes a portion thereof that is different from the third image field of view and wherein the third image field of view and the fourth image field of view together provide a combined forward looking image field of view ahead of the housing.

Referring now to FIG. 6, a cross-sectional view of the wide field of view ultrasound probe 220 with first, second, third, fourth, and fifth transducer subassemblies (240, 242, 244, 246 and 248, respectively) according to yet another embodiment of the present disclosure is shown. Various elements of ultrasound probe 220 are similar to corresponding elements of ultrasound probe 12, with the following differences as explained below. In one embodiment, first, second, third, fourth, and fifth transducer subassemblies (240, 242, 244, 246 and 248, respectively) are generally disposed in a region of the distal tip 46 of probe body 44 (of FIG. 1). Ultrasound transducer subassemblies 240, 242, 244, 246 and 248 are similar to ultrasound transducer subassemblies 40 and 42, discussed above with reference to FIGS. 2-4. However, each of the ultrasound transducer subassemblies 240, 242, 244, 246 and 248 are disposed at an angle with respect to adjacent ones of the ultrasound transducer subassemblies, such that an overall wide field of view of probe 220 is on the order of 360 degrees. In addition, as shown in FIG. 6, an acoustic window 248 is disposed on a perimeter of the probe body 44, in front of respective transducer subassemblies.

As illustrated in FIG. 6, ultrasound transducer subassembly 240 produces a first elevation image field of view indicated by reference numeral 260. The second transducer subassembly 242 produces a second elevation image field of view, indicated by reference numeral 262. A region of overlap between the first and second fields of view (260,262) is illustrated by reference numeral 261. The region of overlap 261 corresponds to an image splice area, wherein ultrasound imaging information of first field of view is combined (and/or spliced) in a suitable manner with ultrasound imaging information of the second field of view in the region of overlap.

In addition, third transducer subassembly 244 produces a third elevation image field of view, indicated by reference numeral 264. A region of overlap between the second and third fields of view (262,264) is illustrated by reference numeral 263. The region of overlap 263 corresponds to an image splice area, wherein ultrasound imaging information of second field of view is combined (and/or spliced) in a suitable manner with ultrasound imaging information of the third field of view in the region of overlap.

Similarly, fourth transducer subassembly 246 produces a fourth elevation image field of view, indicated by reference numeral 266. A region of overlap between the third and fourth fields of view (264,266) is illustrated by reference numeral 265. The region of overlap 265 corresponds to an image splice area, wherein ultrasound imaging information of third field of view is combined (and/or spliced) in a suitable manner with ultrasound imaging information of the fourth field of view in the region of overlap. Still further, fifth transducer subassembly 248 produces a fifth elevation image field of view, indicated by reference numeral 268. A region of overlap between the fourth and fifth fields of view (266,268 is illustrated by reference numeral 267. The region of overlap 267 corresponds to an image splice area, wherein ultrasound imaging information of fourth field of view is combined (and/or spliced) in a suitable manner with ultrasound imaging information of the fifth field of view in the region of overlap.

Furthermore, as previously discussed, first transducer subassembly 240 produces a first elevation image field of view, indicated by reference numeral 260. A region of overlap between the fifth and first fields of view (268,260) is illustrated by reference numeral 269. The region of overlap 269 corresponds to an image splice area, wherein ultrasound imaging information of fifth field of view is combined (and/or spliced) in a suitable manner with ultrasound imaging information of the first field of view in the region of overlap. In still another embodiment, the ultrasound imaging probe further includes a third ultrasound imaging transducer array subassembly having a third image field of view, a fourth ultrasound imaging transducer array subassembly having a fourth image field of view, and a fifth ultrasound imaging transducer array subassembly having a fifth image field of view. The fifth ultrasound imaging transducer array subassembly is disposed at an angle greater than or equal to ninety degrees and less than or equal to one hundred eighty degrees (90°≦angle≦180°) with respect to the fourth ultrasound imaging transducer array subassembly. The fourth ultrasound imaging transducer array subassembly is disposed at an angle greater than or equal to ninety degrees and less than or equal to one hundred eighty degrees (90°≦angle≦180°) with respect to the third ultrasound imaging transducer array subassembly. The third ultrasound imaging transducer array subassembly is disposed at an angle greater than or equal to ninety degrees and less than or equal to one hundred eighty degrees (90°≦angle≦180°) with respect to the second ultrasound imaging transducer array subassembly.

Furthermore, the second image field of view includes a portion thereof that is different from the third image field of view, the third image field of view includes a portion thereof that is different from the fourth image field of view, the fourth image field of view includes a portion thereof that is different from the fifth image field of view, and the fifth image field of view includes a portion thereof that is different from the first image field of view. Together the first, second, third, fourth and fifth image fields of view provide a combined field of view. The combined field of view of the combined ultrasound image is on the order of approximately three hundred sixty degrees, oriented perpendicular to and about a principal axis of the probe.

In one embodiment, the first, second, third, fourth and fifth ultrasound imaging transducer array subassemblies include flat matrix sensor assemblies. The flat matrix sensor assemblies each include an acoustic window coupled to a sensor stack, the sensor stack coupled to a flip chip ASIC, and the flip chip ASIC coupled to cabling interconnections. The first, second, third, fourth and fifth ultrasound imaging transducer array subassemblies are responsive to transmit beamforming signals for transmitting sound energy into and receiving echo energy from the respective first, second, third, fourth and fifth fourth fields of view. Still further, apertures of the first, second, third, fourth and fifth ultrasound imaging transducer array subassemblies facilitate a scanning direction perpendicular to the principal axis of the probe.

In another embodiment, the ultrasound imaging probe further includes a controller coupled to the first, second, third, fourth and fifth ultrasound imaging transducer array subassemblies. The controller includes any suitable controller or processing circuitry for combining ultrasound imaging information received from the first, second, third, fourth and fifth ultrasound imaging transducer array subassemblies to produce data representative of a combined field of view ultrasound image.

According to an embodiment of the present disclosure, an ultrasound imaging probe incorporates multiple flat matrix array sensor assemblies positioned at angles to each other to provide for a wider field of view. For cylindrical probes, the array aperture in the scanning direction perpendicular to the axis of the probe is limited by the diameter of the probe. The array aperture is further limited to 90 degrees with characteristic phased array technology. However, with the embodiments of the present disclosure, more that one flat array is used to increase the array aperture field of view of the cylindrical probe. In one embodiment, five arrays are arranged around the principal axis of the probe to provide a full 360 degrees field of view, wherein each of the arrays scan approximately one fifth of the overall field of view. Additional arrays implemented within the probe are also possible. In addition to the arrays arranged in a manner around a periphery of the cylindrical probe, an additional array or arrays may be placed in proximity to the front of the probe to provide views ahead of the probe device, as well as to the side of it.

In another embodiment of the present disclosure, an ultrasound diagnostic imaging system includes an ultrasound imaging probe and a controller coupled to the first and second ultrasound imaging transducer array subassemblies for combining ultrasound imaging information received from the first and second ultrasound imaging transducer array subassemblies to produce data representative of a combined field of view ultrasound image. The controller controls a scanning of elements of the first and second ultrasound imaging transducer array subassemblies, wherein scanning includes phasing elements with at least one selected from the group consisting of full and partial projection to an imaging target. The controller further controls a scanning of elements of the first and second ultrasound imaging transducer array subassemblies, wherein scanning includes scanning with only the array or portion of the array centered in a zone of interest within the combined field of view and over scanning at edges of the centered zone to permit averaging at an edge of the zone of interest and adjusting a gain of each array.

In yet another embodiment, the ultrasound diagnostic imaging system further includes a controller or processor for splicing the first and second field of view images into the combined field of view image and a display for displaying the combined field of view image.

One or more methods may be used to scan the imaging planes with the cylindrical probe device according to the embodiments of the present disclosure, for example, for the embodiment of a 360 degree scan around the principal axis of the ultrasound probe. One method includes properly phasing each element that has sufficient projected aperture toward the target when scanning an acoustic line. Elements that do not present favorably toward the target are not used. By this method, acoustic scan lines advance around the axis of the device like spokes from a wheel. In addition, multiple scan lines can be fired in directions which are sufficiently isolated from each other.

A second method includes processing an image sector from each array to produce a virtual apex in the center of the cylindrical probe imaging device and then display the image sector from each array edge to edge to complete the view. Overlapping edge scan lines can be used to average and adjust the gains of each array.

Moreover, the embodiments of the present disclosure may include variations, such as, a wide field of view 3D imaging probe composed of multiple flat matrix array sensor subassemblies positioned at angles to each other. Scanning may be accomplished by phasing elements with full or partial projection to a target. Scanning may also be accomplished by using only the array centered in a given zone with overscanning at the edges to permit averaging at the edge and adjusting the gain of each array. The embodiments further include an ultrasound imaging system connected to the probe featuring the wide field of view, the ultrasound imaging system being used to control, splice, and display a wide field of view format ultrasound diagnostic image. Applications for use of the embodiments of the present disclosure may include intracardiac ultrasound, transesophageal echo, semi-invasive ultrasound, intracavity surgical guidance, transrectal, transvaginal ultrasound imaging, and other similar applications.

According to yet another embodiment, a method of fabricating an ultrasound imaging probe includes providing a first ultrasound imaging transducer array subassembly having a first image field of view and coupling a second ultrasound imaging transducer array subassembly having a second image field of view to the first ultrasound imaging transducer array subassembly. The second ultrasound imaging transducer array subassembly is disposed at an angle greater than or equal to ninety degrees and less than or equal to one hundred eighty degrees (90°≦angle≦180°) with respect to the first ultrasound imaging transducer array subassembly, wherein the second image field of view includes a portion thereof that is different from the first image field of view and wherein the first image field of view and the second image field of view together provide a combined image field of view.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

1. An ultrasound imaging probe comprising:
a first ultrasound imaging transducer array subassembly having a first image field of view; and
a second ultrasound imaging transducer array subassembly having a second image field of view, the second ultrasound imaging transducer array subassembly being disposed at an angle greater than or equal to ninety degrees and less than or equal to one hundred eighty degrees (90°≦angle≦180°) with respect to the first ultrasound imaging transducer array subassembly, wherein the second image field of view includes a portion thereof that is different from the first image field of view and wherein the first image field of view and the second image field of view together provide a combined image field of view.

2. The ultrasound imaging probe of claim 1, wherein the combined image field of view further includes a portion thereof in common with both the first and second image fields of view.

3. The ultrasound imaging probe of claim 1, wherein the second field of view overlaps with the first field of view in an image splice area.

4. The ultrasound imaging probe of claim 1, further comprising:
a housing, wherein the first and second ultrasound imaging transducer array subassemblies are disposed within the housing.

5. The ultrasound imaging probe of claim 4, wherein the first and second ultrasound imaging transducer array subassemblies are further disposed within the housing along a principal axis of the housing.

6. The ultrasound imaging probe of claim 4, wherein the first and second ultrasound imaging transducer array subassemblies are further disposed within the housing canted at an angle to a principal axis of the housing.

7. The ultrasound imaging probe of claim 1, wherein the first ultrasound imaging transducer array subassembly includes a flat matrix sensor assembly.

8. The ultrasound imaging probe of claim 7, further wherein the flat matrix sensor assembly includes an acoustic window coupled to a sensor stack, the sensor stack coupled to a flip chip ASIC, and the flip chip ASIC coupled to cabling interconnections.

9. The ultrasound imaging probe of claim 1, wherein the second ultrasound imaging transducer array subassembly includes a flat matrix sensor assembly.

10. The ultrasound imaging probe of claim 9, further wherein the flat matrix sensor assembly includes an acoustic window coupled to a sensor stack, the sensor stack coupled to a flip chip ASIC, and the flip chip ASIC coupled to cabling interconnections.

11. The ultrasound imaging probe of claim 1, wherein the first ultrasound imaging transducer array subassembly is responsive to transmit beamforming signals for transmitting sound energy into and receiving echo energy from the first field of view.

12. The ultrasound imaging probe of claim 1, wherein the second ultrasound imaging transducer array subassembly is responsive to transmit beamforming signals for transmitting sound energy into and receiving echo energy from the second field of view.

13. The ultrasound imaging probe of claim 1, wherein the ultrasound imaging probe includes a cylindrical probe having a principal axis along a length dimension of the probe.

14. The ultrasound imaging probe of claim 13, further wherein apertures of the first and second ultrasound imaging transducer array subassemblies facilitate a scanning direction perpendicular to the principal axis of the probe.

15. The ultrasound imaging probe of claim 1, wherein the ultrasound imaging probe includes one selected from the group consisting of an ultrasound imaging catheter and an intracavity probe.

16. The ultrasound imaging probe of claim 1, further comprising:
a third ultrasound imaging transducer array subassembly having a third image field of view, the third ultrasound imaging transducer array subassembly being disposed at an angle greater than or equal to ninety degrees and less than or equal to one hundred eighty degrees (90°≦angle≦180°) with respect to the second ultrasound imaging transducer array subassembly, wherein the second image field of view includes a portion thereof that is different from the third image field of view, wherein together the first, second, and third image fields of view provide a combined field of view.

17. The ultrasound imaging probe of claim 16, further comprising:
a housing, wherein the first, second and third ultrasound imaging transducer array subassemblies are disposed within the housing.

18. The ultrasound imaging probe of claim 17, wherein the first, second and third ultrasound imaging transducer array subassemblies are further disposed within the housing along a principal axis of the housing.

19. The ultrasound imaging probe of claim 1, further comprising: a housing, wherein the first and second ultrasound imaging transducer array subassemblies are disposed within the housing along a principal axis of the housing to provide the combined image field of view around a periphery of the housing; and
a third ultrasound imaging transducer array subassembly having a third image field of view, the third ultrasound imaging transducer array subassembly being disposed within the housing and canted at an angle with respect to the principal axis of the housing, wherein the third ultrasound imaging transducer array subassembly provides a forward looking image field of view ahead of the housing.

20. The ultrasound imaging probe of claim 19, still further comprising:
a fourth ultrasound imaging transducer array subassembly having a fourth image field of view, the fourth ultrasound imaging transducer array being disposed at an angle greater than or equal to ninety degrees and less than or equal to one hundred eighty degrees (90°≦angle≦180°) with respect to the third ultrasound imaging transducer array, the fourth ultrasound imaging transducer array subassembly further being disposed within the housing and canted at an angle with respect to the principal axis of the housing, wherein the fourth image field of view includes a portion thereof that is different from the third image field of view and wherein the third image field of view and the fourth image field of view together provide a combined forward looking image field of view ahead of the housing.

21. The ultrasound imaging probe of claim 1, further comprising:
a third ultrasound imaging transducer array subassembly having a third image field of view;
a fourth ultrasound imaging transducer array subassembly having a fourth image field of view; and
a fifth ultrasound imaging transducer array subassembly having a fifth image field of view, the fifth ultrasound imaging transducer array subassembly being disposed at an angle greater than or equal to ninety degrees and less than or equal to one hundred eighty degrees (90°≦angle≦180°) with respect to the fourth ultrasound imaging transducer array subassembly, the fourth ultrasound imaging transducer array subassembly being disposed at an angle greater than or equal to ninety degrees and less than or equal to one hundred eighty degrees (90°≦angle≦180°) with respect to the third ultrasound imaging transducer array subassembly, the third ultrasound imaging transducer array subassembly being disposed at an angle greater than or equal to ninety degrees and less than or equal to one hundred eighty degrees (90°≦angle≦180°) with respect to the second ultrasound imaging transducer array subassembly, wherein the second image field of view includes a portion thereof that is different from the third image field of view, the third image field of view includes a portion thereof that is different from the fourth image field of view, the fourth image field of view includes a portion thereof that is different from the fifth image field of view, and the fifth image field of view includes a portion thereof that is different from the first image field of view, wherein together the first, second, third, fourth, and fifth image fields of view provide a combined field of view.

22. The ultrasound imaging probe of claim 21, wherein the combined field of view of the combined ultrasound image is on the order of approximately three hundred sixty degrees, oriented perpendicular to and about a principal axis of the probe.

23. The ultrasound imaging probe of claim 21, further comprising:
a housing, wherein the first, second, third, fourth, and fifth ultrasound imaging transducer array subassemblies are disposed within the housing along a principal axis of the housing.

24. The ultrasound imaging probe of claim 21, wherein the first, second, third, fourth and fifth ultrasound imaging transducer array subassemblies include flat matrix sensor assemblies.

25. The ultrasound imaging probe of claim 24, further wherein the flat matrix sensor assemblies each include an acoustic window coupled to a sensor stack, the sensor stack coupled to a flip chip ASIC, and the flip chip ASIC coupled to cabling interconnections.

26. The ultrasound imaging probe of claim 21, wherein the first, second, third, fourth and fifth ultrasound imaging transducer array subassemblies are responsive to transmit beamforming signals for transmitting sound energy into and receiving echo energy from the respective first, second, third, fourth and fifth fourth fields of view.

27. The ultrasound imaging probe of claim 21, wherein the ultrasound imaging probe includes a cylindrical probe having a principal axis along a length dimension of the probe.

28. The ultrasound imaging probe of claim 27, wherein apertures of the first, second, third, fourth and fifth ultrasound imaging transducer array subassemblies facilitate a scanning direction perpendicular to the principal axis of the probe.

29. The ultrasound imaging probe of claim 21, wherein the ultrasound imaging probe includes one selected from the group consisting of an ultrasound imaging catheter and an intracavity probe.

30. The ultrasound imaging probe of claim 1, further comprising:
a controller coupled to the first and second ultrasound imaging transducer array subassemblies for combining ultrasound imaging information received from the first and second ultrasound imaging transducer array subassemblies to produce data representative of a combined field of view ultrasound image.

31. The ultrasound imaging probe of claim 21, further comprising:
a controller coupled to the first, second, third, fourth and fifth ultrasound imaging transducer array subassemblies for combining ultrasound imaging information received from the first, second, third, fourth and fifth ultrasound imaging transducer array subassemblies to produce data representative of a combined field of view ultrasound image.

32. An ultrasound diagnostic imaging system comprising:
an ultrasound imaging probe, the ultrasound imaging probe including: a first ultrasound imaging transducer array subassembly having a first image field of view; and a second ultrasound imaging transducer array subassembly having a second image field of view, the second ultrasound imaging transducer array subassembly being disposed at an angle greater than or equal to ninety degrees and less than or equal to one hundred eighty degrees (90°≦angle≦180°) with respect to the first ultrasound imaging transducer array subassembly, wherein the second image field of view includes a portion thereof that is different from the first image field of view and wherein the first image field of view and the second image field of view together provide a combined image field of view, and
a controller coupled to the first and second ultrasound imaging transducer array subassemblies for combining ultrasound imaging information received from the first and second ultrasound imaging transducer array subassemblies to produce data representative of a combined field of view ultrasound image.

33. The ultrasound diagnostic imaging system of claim 32, wherein the controller controls a scanning of elements of the first and second ultrasound imaging transducer array subassemblies, wherein scanning includes phasing elements with at least one selected from the group consisting of full and partial projection to an imaging target.

34. The ultrasound diagnostic imaging system of claim 32, wherein the controller controls a scanning of elements of the first and second ultrasound imaging transducer array subassemblies, wherein scanning includes scanning with only the array or portion of the array centered in a zone of interest within the combined field of view and overscanning at edges of the centered zone to permit averaging at an edge of the zone of interest and adjusting a gain of each array.

35. The ultrasound diagnostic imaging system of claim 32, further comprising:
means for splicing the first and second field of view images into the combined field of view image; and
display means for displaying the combined field of view image.

36. A method of fabricating an ultrasound imaging probe comprising:
providing a first ultrasound imaging transducer array subassembly having a first image field of view; and
coupling a second ultrasound imaging transducer array subassembly having a second image field of view to the first ultrasound imaging transducer array subassembly and being disposed at an angle greater than or equal to ninety degrees and less than or equal to one hundred eighty degrees (90°≦angle≦180°) with respect to the first ultrasound imaging transducer array subassembly, wherein the second image field of view includes a portion thereof that is different from the first image field of view and wherein the first image field of view and the second image field of view together provide a combined image field of view.
